(19) United States
(12) Patent Application Publication
(10) Pub. No.: US 2015/0314343 A1
(43) Pub. Date: Nov. 5, 2015

(54) SELF-CLEANING RETRACTABLE WASHING HEAD WITH PNEUMATIC DRIVE

(71) Applicant: BRINOX, D.O.O., Medvode (SI)

(72) Inventor: Slavislav SAVIC, Ljubljana (SI)

(21) Appl. No.: 14/651,371

(22) PCT Filed: Dec. 9, 2013
(86) PCT No.: PCT/SI2013/000078

§ 371 Date: Jun. 11, 2015

(30) Foreign Application Priority Data
Dec. 12, 2012 (SI) P-201200374

(51) Int. Cl. B08B 9/093; B05B 15/02

(52) U.S. Cl. CPC B08B 9/0936; B05B 15/025

(57) ABSTRACT

A self-cleaning retract washing head with a pneumatic drive designed for efficient washing of vessels or containers and intermediate components for the preparation of solutions in pharmaceutical and food industry, said solutions being at an over-pressure of up to 6 bar, wherein the constructional solution to the washing head of the invention provides for a simple and efficient self-cleaning of the washing head. The self-cleaning retract washing head (1) with the pneumatic drive is provided with a movable bar (2) with a washing ring (5), wherein at the end of the bar (2) on the washing ring (5) an annular element (3) with grooves (3′) is pivotably arranged, which grooves cause rotation of the annular element (3).

The object of the invention is a self-cleaning retract washing head with a pneumatic drive designed for efficient washing of vessels or containers and intermediate components for the preparation of solutions in pharmaceutical and food industry, said solutions being under an overpressure of up to 6 bar, wherein the constructional solution to the washing head of the invention provides for a simple and efficient self-cleaning of the washing head. The invention belongs to class B 08 9/093 of the International Patent Classification.

The technical problem that is successfully solved by the present invention is a constructional solution to and an embodiment of a washing head that should allow washing of various vessels and/or systems under pressure, and apart from that self-cleaning of the washing head should be foreseen after the washing of vessels and/or systems has been completed.

A known embodiment of a washing head with a pneumatic drive is disclosed in patent document DK201170365. The washing head for cleaning vessels comprises a body adapted to be connected to a wall of the vessel, and a washing insert that moves within the body and is able to assume two extreme positions relative to the body. In one extreme position the washing insert is retracted into the body and seals the contact between the body of the washing head and the washing insert, when the insert is in an advanced position, washing takes place. A disadvantage of such embodiment resides in the fact that remains of a washing agent or the content of the vessel are still present on contact surfaces of the seat of the washing insert and the gasket as well as within the washing head, said remains having a detrimental effect on further methods, and what is more, drying of the system and the head is difficult.

A self-cleaning retract washing head 1 of the invention is provided at an end of a bar 2 with a rotating annular element 3 with grooves, which head allows a perfect washing of a seat of the head 1 (at the beginning of opening), into which bar 2 the seat is integrated, and washing of the contact sealing surface between itself and the bar 2 while the system or

The invention will be described in more detail by way of an embodiment and figures, in which:

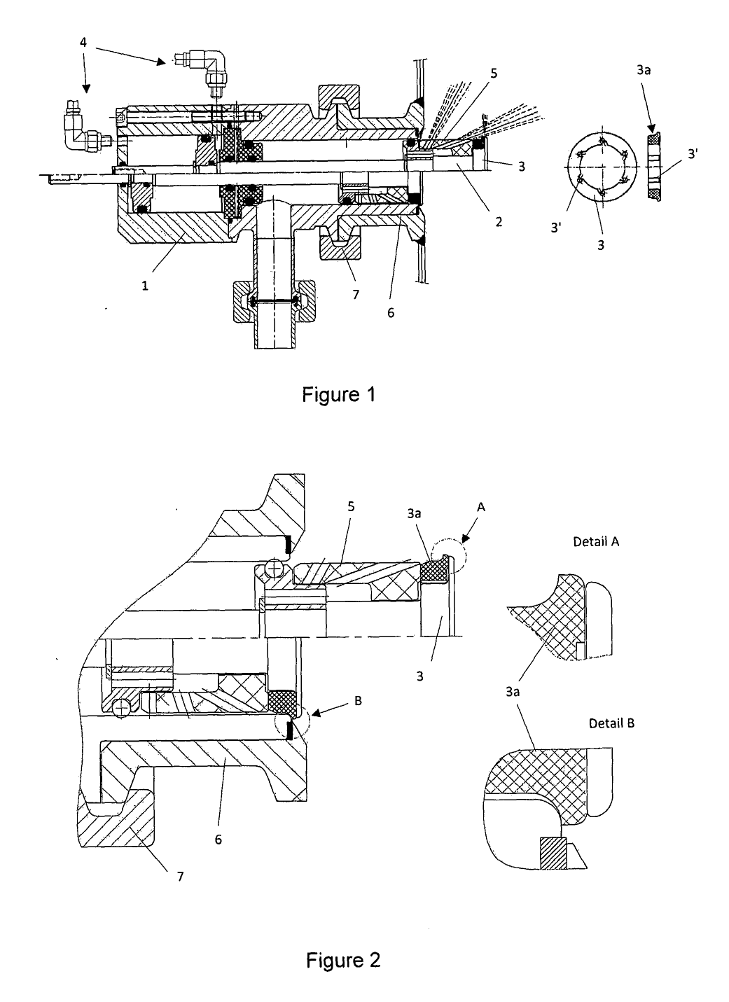

FIG. 1 shows a cross-section of a washing head of the invention in a closed position;

FIG. 2 shows a detail of the washing head of the invention;

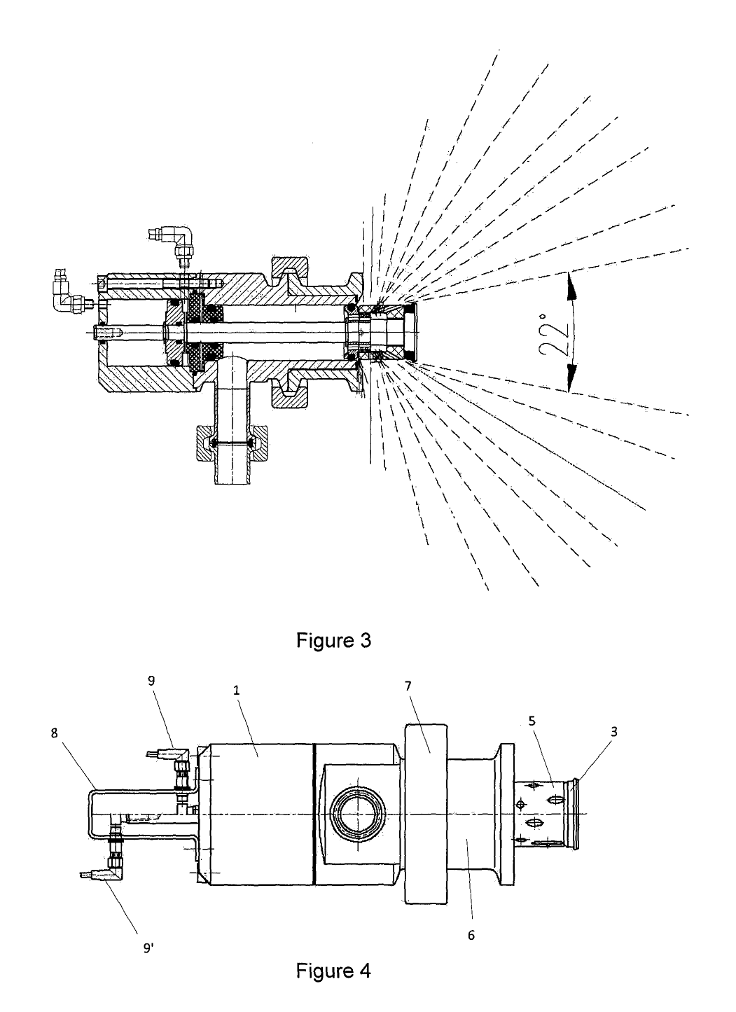

FIG. 3 is an illustration of the operating range of the washing head of the invention;

FIG. 4 is an illustration of indication of position of the washing head of the invention;

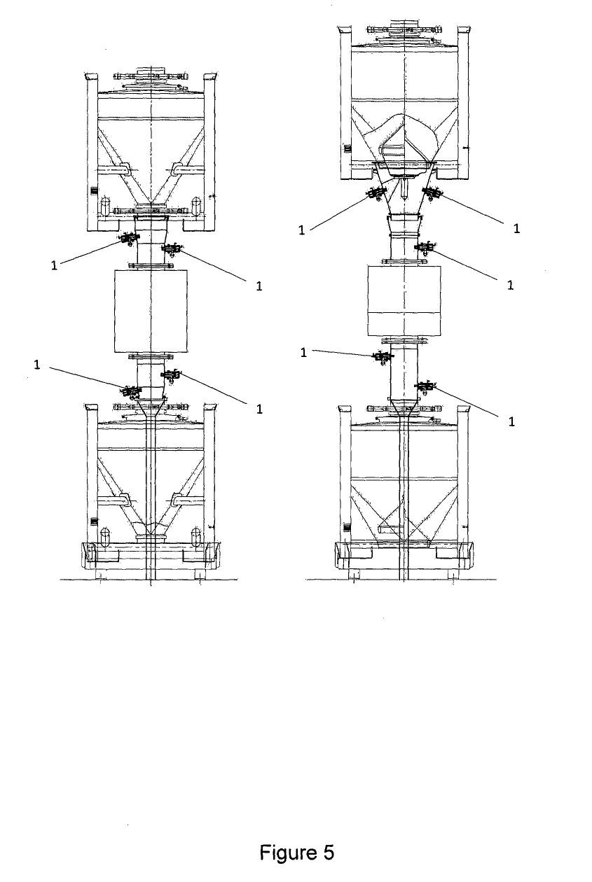

FIG. 5, 6 is a schematic representation of arrangement of washing heads in various vessels and connections.

A retract washing head 1 with a pneumatic drive is embodied in a way that its opening and closing during washing is performed by way of compressed air (2-5 bar) which is supplied to a pneumatic cylinder of the head 1 through connections 4 at the rear side (constituent part of the washing head 1). At the end of a bar 2 a ring 5 with washing nozzles is arranged, on which an annular element 3 with grooves 3′ is pivotably arranged. Due to the fact that the construction of the front part of the bar 2 and of the rotating annular element 3 with the grooves 3′ is special, the head 1 of the invention can be used in various positions on systems and vessels designed for the preparation of solutions in pharmaceutical and food industry, said solutions being at an overpressure of up to 6 bar.

The annular element 3 has a circumferentially arranged sealing ring 3a which is exposed to washing when the bar 2 is extended, whereas it provides with its shaped edge (detail B on FIG. 2) for perfect sealing when the bar 2 is retracted in the body of the head 1.

During a washing process the washing head 1 of the invention can be immersed in a liquid or powder medium in the closed position. After a system or a vessel is emptied, a washing agent is delivered into the interior of the washing head 1 or the bar 2. By supplying compressed air through the attachments 4 at the rear side of the pneumatic cylinder, the bar 2 shifts to an open position, and the ring 5 starts rotating around its axis. The ring 5 is provided with boreholes arranged at various angles and eccentric to the axis of rotation, and therefore a large section (cone 158°) of the system or the vessel can be washed when the ring 5 rotates.

The grooves 3′ on the annular element 3 (in the shape of deepened channels) cause the annular element 3 to rotate and hence perfect washing between same and the front part of the bar 2 (contact sealing surface).

Compared to known embodiments the washing head 1 of the invention provides for an efficient and perfect washing of the seat (at the beginning of opening), into which the washing head 1 is installed, and washing of the contact sealing surface between said head and the bar 2 during washing of the system or the vessel. This is rendered possible by the annular element 3 with grooves that is not present on other known washing heads.

The washing head 1 of the invention is installed into a system or a vessel by means of a connection 6 welded to an outer cover or a tube, into which the washing head 1 is fastened by a collar 7.

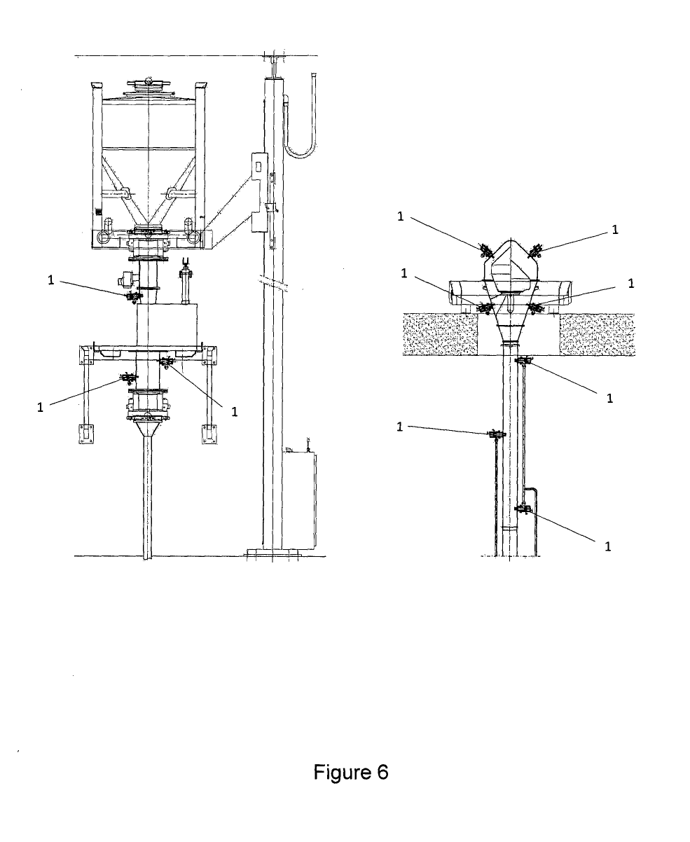

As the front surface of the bar 2 is out of reach of washing (due to limitations of constructional solution), an installation of at least two washing heads 1 of the invention is recommended at various positions: one washing head 1 washes the front surface and the other head 1 washes other surfaces and vice versa. Installations of this type are shown in FIGS. 5 and 6.

Due to a bilaterally operating pneumatic cylinder (supply of compressed air through the radial connections 4), an individual washing head 1 can be closed during washing (cyclic operation). The sequence and the time of operation of individual washing heads 1 can thus be selected and also the efficiency and the cost effectiveness of washing (lower consumption of water, washing agent and energy) can be influenced.

When the washing head 1 of the invention is used in conditions where the washing is to be monitored (open-closed), a support 8 with two position indicators 9, 9′ is arranged on the rear part of the pneumatic cylinder of the washing head 1, said indicators indicating the status washing—not washing. The washing head 1 of the invention further allows drying of the system or the vessel, into which it is installed. In this case, hot, filtered air (max. 90° C.) is blown through the washing head instead of a washing agent.

1. A self-cleaning retract washing head 1 with a pneumatic drive, wherein the washing head 1 is provided with a movable bar 2 with a washing ring 5
characterized in that
at the end of the bar (2) on the washing ring (5) an annular element (3) with grooves (3′) is pivotably arranged, which grooves cause rotation of the annular element (3).

2. Self-cleaning retract head 1 according to claim 1
characterized in that
the annular element (3) has a circumferentially arranged sealing ring (3a).

3. Self-cleaning retract head 1 according to claims 1
characterized in that
a support (8) with two position indicators (9, 9′) is arranged at the rear part of the pneumatic cylinder of the washing head (1).

4. Self-cleaning retract head 1 according to claim 1
characterized in that
at least two heads (1) are installed into vessels, containers and/or intermediate components at different positions in a way that one head (1) washes the front surface of the bar (2) and other heads (2) wash other surfaces and vice versa.
